(19) United States
(12) Patent Application Publication
(10) Pub. No.: US 2015/0339786 A1
(43) Pub. Date: Nov. 26, 2015

(54) FORENSIC SYSTEM, FORENSIC METHOD, AND FORENSIC PROGRAM

(71) Applicant: UBIC, Inc., Minato-ku Tokyo (JP)

(72) Inventors: Masahiro Morimoto, Tokyo (JP); Yoshikatsu Shirai, Tokyo (JP); Hideki Takeda, Tokyo (JP); Kazumi Hasuko, Tokyo (JP)

(73) Assignee: UBIC, Inc., Tokyo (JP)

(21) Appl. No.: 14/434,705

(22) PCT Filed: Oct. 9, 2013
(86) PCT No.: PCT/JP2013/077443

§ 371 Date: Aug. 5, 2015

(30) Foreign Application Priority Data
Oct. 9, 2012 (JP) 2012-224584

(51) Int. Cl. G06Q 50/18; G06F 17/30; G06Q 10/10; G06F 3/0481

(52) U.S. Cl. CPC G06Q 50/18; G06F 3/04817; G06F 17/30011; G06F 17/3053; G06Q 10/10

(57) ABSTRACT

A forensic system including: a determination acquiring unit that acquires, as performance information, at least one of result information indicating a result of determination of relevance of plural pieces of document data included in digital information to a lawsuit performed by a user and progress information indicating information relating to a progress speed of the determination of relevance performed by the user; a recording unit that records the performance information acquired by the determination acquiring unit; a prediction information generating unit that generates prediction information relating to at least one of the result information and the progress information; an information comparing unit that compares the performance information with the prediction information; and an icon generating unit that generates an icon for presenting an evaluation of the determination of relevance performed by the user based on a comparison result by the information comparing unit.

### TECHNICAL FIELD

The present invention relates to a forensic system, a forensic method and a forensic program, and more particularly, to a forensic system, a forensic method and a forensic program for collecting document data related to a lawsuit.

### BACKGROUND ART

In the related art, when a crime or a legal dispute relating to a computer such as unauthorized access or confidential information leakage occurs, means or a technique for collecting and analyzing devices, data or electronic records necessary for cause examination or criminal investigation to clarify legal evidentiality has been proposed.

Further, in a US civil suit, since eDiscovery (electronic discovery) or the like is required, both an accuser and a defendant in a lawsuit should submit related digital information as evidence. Thus, digital information recorded in a computer or a server should be presented as evidence.

On the other hand, in the current business world, since most information is prepared through a computer due to the rapid development and spread of IT technology, a large amount of digital information is oversupplied even in the same company.

For this reason, in the course of performing preparation work for producing evidentiary materials for a court of law, an error in which confidential digital information that is not necessarily related to a lawsuit is included as the evidentiary materials may easily occur. Further, confidential document data that is not related to the lawsuit may also be produced.

In recent years, a technique relating to document data in a forensic system has been proposed in PTL 1 to PTL 3. PTL 1 discloses a forensic system that designates a specific person from at least one target person included in target person information related to a document submission order, extracts only digital document data that is accessed by the specific person based on access history information relating to the designated specific person, sets accessory information indicating whether each of the document files of the extracted digital document data is related to the lawsuit, and outputs a document file relating to the lawsuit based on the accessory information.

Further, PTL 2 discloses a forensic system that displays recorded digital information, sets target person specifying information indicating which person among target persons included in target person information each of the plurality of document files relates to, sets the set target person specifying information to be recorded in a storing unit, designates at least one target person, retrieves a document file in which the target person specifying information corresponding to the designated target person is set, sets accessory information indicating whether the retrieved document file is related to a lawsuit, and outputs the document file relating to the lawsuit based on the accessory information through a display unit.

In addition, PTL 3 discloses a forensic system that receives designation of at least one document file included in digital document data, receives designation of a language for translating the designated document file, translates the document file in which the designation is received into the language in which the designation is received, extracts a common document file that represents the same content as that of the designated document file from the digital document data recorded in a recording unit, generates translation related information indicating that the extracted common document file is translated by quoting the translation content of the translated document file, and outputs a document file relating to a lawsuit based on the translation relevancy information.

### CITATION LIST

### Patent Literature

[PTL 1] JP-A-2011-209930

[PTL 2] JP-A-2011-209931

[PTL 3] JP-A-2012-32859

### SUMMARY OF INVENTION

### Technical Problem

However, for example, in the forensic system in PTL 1 to PTL 3, a huge amount of document data of target persons who use a plurality of computers and a server should be collected.

Work called “review” for determining whether the huge amount of digital document data is valid as evidentiary materials for a lawsuit should be performed as visual confirmation by a user called a “reviewer”, and the document data should be determined piece by piece, which causes a problem in that the accuracy or efficiency of the determination work depends on the ability or physical condition of the reviewer.

The invention has been made in consideration of such situation, and an object of the invention is to provide a forensic system, a forensic method, and a forensic program for appropriately performing feedback using an icon according to a state of processing a user called a reviewer or the degree of relevance of document data during review to a lawsuit, to thereby make it possible to maintain the motivation of the user and to improve efficiency of the review.

### Solution to Problem

According to an aspect of the invention, there is provided a forensic system that acquires digital information recorded in a plurality of computers or a server and analyzes the acquired digital information, including: a determination acquiring unit that acquires, as performance information, at least one of result information indicating a result of determination of relevance to a lawsuit performed by a user and progress information indicating information relating to the speed of progress of the relevance determination performed by the user with respect to a plurality of pieces of document data included in the digital information; a recording unit that records the performance information acquired by the determination acquiring unit; a prediction information generating unit that generates prediction information relating to at least one of the result information and the progress information; an information comparing unit that compares the performance information with the prediction information; and an icon generating unit that generates an icon for presenting evaluation of the relevance determination performed by the user based on a comparison result in the information comparing unit.

The “document data” refers to data including one or more words. As an example of the document data, electronic mail, presentation material, spreadsheet material, a meeting reference, a contract, an organization chart, a business plan or the like may be used.

The “relevance determination” refers to an operation of determining the presence or absence of necessity for submission in a lawsuit with respect to document data. The relevance determination may be an operation of assigning of classification code according to the degree of relevance.

The “result information” refers to a result of determination of relevance to a lawsuit performed by a user with respect to document data. The result information may represent a classification code indicating the degree of relevance to the lawsuit assigned to the document data by the user.

The “progress information” refers to information relating to the speed of relevance determination performed by a user. The progress information may represent the number of pieces of document data for which the user performs the relevance determination per unit of time. Further, the progress information may represent the number of pieces of document data for which the user performs the relevance determination per unit of time with respect to the entirety of the document data for which the relevance determination is necessary.

The “performance information” refers to information relating to at least one piece of result information and progress information.

The “determination acquiring unit” refers to a unit that acquires information relating to a determination result performed by a user with respect to document data.

The “recording unit” refers to a unit that records performance information.

The “prediction information” refers to information relating to prediction of relevance determination performed by a user. The prediction information may be information relating to at least one of result information and progress information.

The “prediction information generating unit” refers to a unit that generates prediction information. The prediction information generating unit may generate prediction information relating to at least one of result information and progress information. Further, the prediction information generating unit may analyze a feature of relevance determination performed by a user from acquired result information, and may generate prediction information relating to the result information based on a result of the analysis. In addition, the prediction information generating unit may further analyze a state of progressing of relevance determination of a different user, and may generate prediction information relating to a progress speed of the relevance determination based on a result of the analysis. Furthermore, the prediction information generating unit may further analyze a state of progressing of a past relevance determination performed by the user, and may generate prediction information relating to a progress speed of the relevance determination based on a result of the analysis.

The “information comparing unit” refers to a unit that compares plural pieces of information. The information comparing unit may perform the comparison when prediction information and performance information include the same information. Specifically, the information comparing unit may compare the prediction information including result information with the performance information including the result information, or may compare the prediction information including the progress information with the performance information including the progress information. Further, the information comparing unit may compare the prediction information including both the progress information and the result information with the performance information including both the progress information and the result information.

The “evaluation” refers to feedback with respect to relevance determination performed by a user. The evaluation may be performed based on a comparison result. Specifically, for example, when progress information acquired as performance information is significantly slower in determination speed than progress information predicted as prediction information, a comment for urging improvement of the determination speed may be presented as the evaluation. Further, when predicted result information is different from result information acquired as performance information, the evaluation may be presented for arousing attention.

The “icon” refers to a simple pattern displayed to present an evaluation to a user. The icon may be a friendly character, for example.

The “icon generating unit” refers to a unit that generates an icon based on a comparison result. Further, the icon generating unit may change a display format of at least one of a motion, a serif and an expression of the icon based on the comparison result. In addition, the icon generating unit may present an evaluation according to content of document data for which a user performs relevance determination. For example, when the user performs the relevance determination with respect to the document data prepared in a specific year, the icon generating unit may present an evaluation for arousing attention.

Further, the forensic system according to the aspect of the invention may further include: an extracting unit that extracts a predetermined number of pieces of document data from the digital information; a display unit that displays the extracted document data on a screen; a result receiving unit that receives the result of the relevance determination performed by the user with respect to the displayed document data; a selecting unit that classifies the extracted document data, for each determination result, based on the determination result, analyzes and selects a keyword that appears commonly in the classified document data; a keyword recording unit that records the selected keyword; a searching unit that searches for the keyword recorded in the keyword recording unit from the document data; and a score calculating unit that calculates a score indicating the relevance between the determination result and the document data using a search result in the searching unit and an analysis result in the selecting unit, in which the prediction information generating unit generates the prediction information relating to the result information using the score.

The “extracting unit” refers to a unit that extracts document data from digital information. The extracting unit may extract the document data via random sampling. Further, the extracting unit may extract the document data based on attributes such as updating time and the date of the document data.

The “display unit” refers to a unit that displays extracted document data. The display unit may display the extracted document data on a client terminal that is used by a user.

The “result receiving unit” refers to a unit that receives a result of relevance determination performed by a user.

The “selecting unit” refers to a unit that selects a keyword. The selecting unit may analyze and select a keyword that appears commonly in document data for which the same determination result is obtained.

The “keyword” refers to a gathering of a character string having a certain meaning in a certain language. For example, keywords in a sentence “perform document classification” may be “document”, “classification”, and “perform”.

The “keyword recording unit” refers to a unit that records a keyword. The keyword recording unit may be provided as a database.

The “searching unit” refers to a unit that searches for a keyword from document data.

The “score calculating unit” refers to a unit that calculates a score of document data. The score calculating unit may calculate the score based on an evaluation value of a keyword included in the document data. The evaluation value may be the amount of information related to each keyword shown in the document data. The evaluation value may be calculated based on appearance frequency or the amount of transmission information related to the keyword in the document data.

The “score” refers to the degree of relevance to a lawsuit in certain document data. The score is calculated based on a keyword included in document data. For example, document data including a keyword having higher necessity for submission in the lawsuit may have a higher score. The document data may be assigned an initial value of the score based on a predetermined condition. For example, the initial score may be calculated based on a keyword that appears in the document data and an evaluation value of each keyword.

Further, according to another aspect of the invention, there is provided a forensic method for acquiring digital information recorded in a plurality of computers and a server and analyzing the acquired digital information, including: a step of acquiring, as performance information, at least one of result information indicating a result of determination of relevance of a plurality of pieces of document data included in the digital information to a lawsuit performed by a user and progress information indicating information relating to a progress speed of the relevance determination performed by the user, through a computer; a step of recording the performance information which is acquired, through the computer; a step of generating prediction information relating to at least one of the result information and the progress information, through the computer; a step of comparing the performance information with the prediction information, through the computer; and a step of generating an icon for presenting evaluation of the relevance determination performed by the user based on a comparison result in the information comparing unit, through the computer.

Further, according to still another aspect of the invention, there is provided a forensic program for acquiring digital information recorded in a plurality of computers and a server and analyzing the acquired digital information, the program allowing a computer to execute functions including: acquiring, as performance information, at least one of result information indicating a result of determination of relevance of a plurality of pieces of document data included in the digital information to a lawsuit performed by a user and progress information indicating information relating to a progress speed of the relevance determination performed by the user with; recording the performance information which is acquired; generating prediction information relating to at least one of the result information and the progress information; comparing the performance information with the prediction information; and generating an icon for presenting evaluation of the relevance determination performed by the user based on a comparison result in the information comparing unit.

### Advantageous Effects of Invention

When the forensic system according to the invention acquires digital information recorded in a plurality of computers or a server and analyzes the acquired digital information, and includes: the determination acquiring unit that acquires, as the performance information, at least one of the result information indicating the result of the determination of the relevance of the plural pieces of document data included in the digital information to the lawsuit performed by the user and the progress information indicating the information relating to the progress speed of the relevance determination performed by the user; the recording unit that records the performance information acquired by the determination acquiring unit; the prediction information generating unit that generates the prediction information relating to at least one of the result information and the progress information; the information comparing unit that compares the performance information with the prediction information; and the icon generating unit that generates the icon for presenting the evaluation for the relevance determination performed by the user based on the comparison result in the information comparing unit it is possible to appropriately perform feedback to a user using the icon according to a state if progressing of review or the degree of relevance of document data during review with a lawsuit, to thereby make it possible to maintain the motivation of the user and to improve efficiency of the review.

Further, when the prediction information generating unit analyzes the feature of the relevance determination performed by the user from the acquired result information and generates the prediction information relating to the result information based on the result of the analysis, it is possible to predict a result of relevance determination performed by the user with respect to certain document data using the system, and when the prediction result is different from an performance determination result of the user, it is possible to arouse the attention of the user.

Further, when the prediction information generating unit further analyzes the state of progressing of the relevance determination of the different user and generates the prediction information relating to the progress speed of the relevance determination based on the result of the analysis, it is possible to predict a result of determination of a specific user with respect to certain document data from a result of relevance determination of a different user using the system, and when the prediction result is different from an performance determination result of the user, it is possible to arouse the attention of the specific user.

In addition, when the prediction information generating unit further analyzes the state of progressing of the past relevance determination performed by the user and generates the prediction information relating to the progress speed of the relevance determination based on the result of the analysis, it is possible to predict a progress speed of review from a past progress speed of a certain user, and when the predicted progress speed is different from actual progress speed of the user, it is possible to arouse the attention of the user.

Furthermore, when the icon generating unit changes the display format of at least one of the motion, the serif and the expression of the icon based on the comparison result, it is possible to present appropriate evaluation according to the state of the user.

### BRIEF DESCRIPTION OF DRAWINGS

FIG. 1 is a block diagram of a forensic system according to a first exemplary embodiment of the invention.

FIG. 2 is a diagram schematically illustrating a review screen according to the first exemplary embodiment of the invention.

FIG. 3 is a diagram schematically illustrating a review screen according to the first exemplary embodiment of the invention.

FIGS. 4A to 4C are diagrams illustrating icons generated by an icon generating unit according to the first exemplary embodiment of the invention.

FIG. 5 is a flowchart illustrating a process in the first exemplary embodiment of the invention.

FIG. 6 is a block diagram of a forensic system according to a second exemplary embodiment of the invention.

FIG. 7 is a graph illustrating an analysis result in a selecting unit according to the second exemplary embodiment of the invention.

FIG. 8 is a flowchart illustrating a prediction information generating process in the second exemplary embodiment of the invention.

### DESCRIPTION OF EMBODIMENTS

### First Exemplary Embodiment

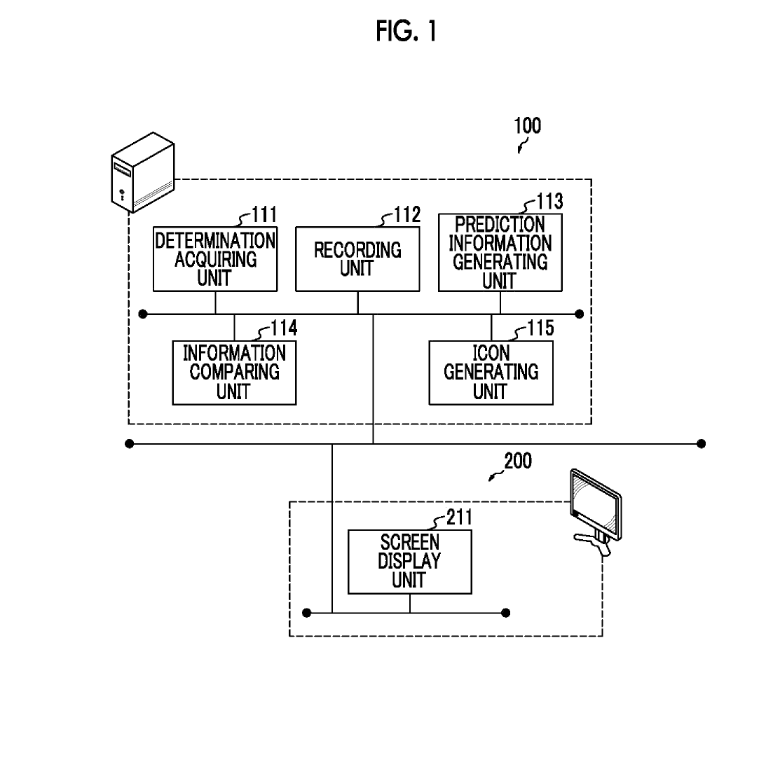

Hereinafter, a first exemplary embodiment of the invention will be described with reference to FIGS. 1 to 5.

A forensic system according to the first exemplary embodiment of the invention acquires digital information recorded in a plurality of computers or a server and analyzes the acquired digital information. The forensic system includes a determination acquiring unit 111 that acquires, as performance information, at least one of result information indicating a result of determination of relevance of plural pieces of document data included in the digital information to a lawsuit performed by a user and progress information indicating information relating to a progress speed of the relevance determination performed by the user; a recording unit 112 that records the performance information acquired by the determination acquiring unit 111; a prediction information generating unit 113 that generates prediction information relating to at least one of the result information and the progress information; an information comparing unit 114 that compares the performance information with the prediction information; and an icon generating unit 115 that generates an icon for presenting evaluation of the relevance determination performed by the user based on a comparison result in the information comparing unit 114.

The forensic system is a computer or a server, and is operated as various functional units by executing a program recorded in a ROM by a CPU based on various inputs. The program may be stored on a recording medium such as a CD-ROM, or may be distributed through a network such as the Internet to be installed in the computer.

In the present exemplary embodiment, a user called a reviewer performs determination of relevance to a lawsuit to extract a document that should be submitted in the lawsuit from the document data. The relevance determination may be performed by assigning a classification code according to the degree of relevance. This operation for determining whether the document data is related to the lawsuit by the system or the user is referred to as review. In the review, document data which is a review target is classified into plural types based on the degree of relevance to the lawsuit or the method of relevance to the lawsuit.

The document data refers to information including one or more words. As an example of the document data, electronic mail, presentation material, spreadsheet material, a meeting reference, a contract, an organization chart, a business plan or the like may be used. Further, scan data may be considered as document data. In this case, an optical character reader (OCR) device may be provided in the forensic system to convert the scan data into text data.

FIG. 1 is a block diagram of the forensic system according to the first exemplary embodiment. In the present exemplary embodiment, the forensic system includes a server apparatus 100 and a client terminal 200.

The server apparatus 100 and the client terminal 200 are connected to each other through a communication network. The communication network refers to a wired or wireless communication line. For example, a telephone line, the Interne line or the like may be used as the communication line.

The server apparatus 100 includes the determination acquiring unit 111, the recording unit 112, the prediction information generating unit 113, the information comparing unit 114, and the icon generating unit 115.

In the present exemplary embodiment, the respective components are mounted on the server apparatus 100, but may be mounted on separate housings.

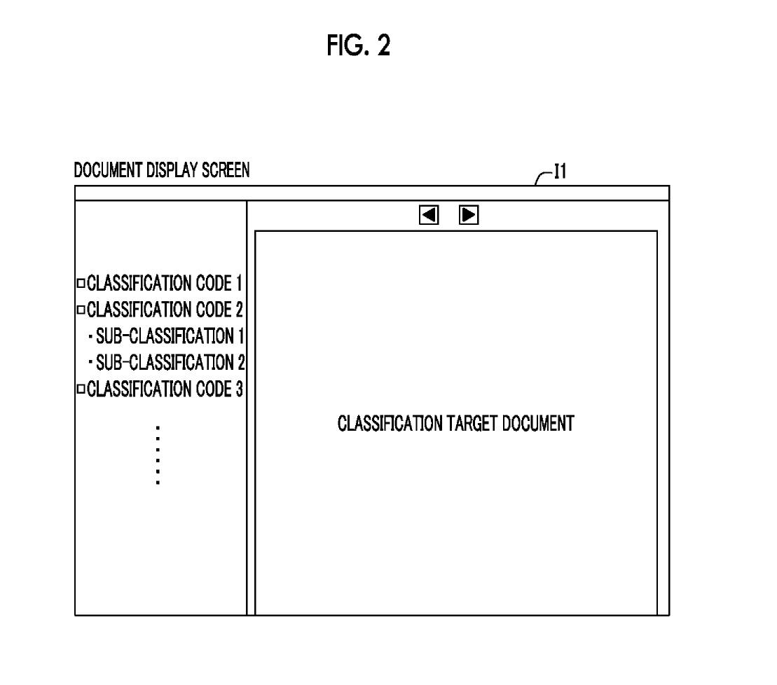

The client terminal 200 is a computer, and includes a screen display unit 211 that displays a review screen I1 shown in FIG. 2 and an indicating unit 290 (not shown in FIG. 1).

The screen display unit 211 refers to a display (a liquid crystal display, a CRT monitor, an organic EL display or the like). Further, the indicating unit 290 refers to a mouse or a keyboard.

The user is connected to the server apparatus 100 through the client terminal 200, and performs review on the review screen I1 displayed by the screen display unit 211.

Functions of the respective components will be described with reference to FIG. 1.

The determination acquiring unit 111 acquires performance information related to relevance determination performed by a user with respect to document data. The performance information includes at least one of result information and progress information.

The result information refers to information indicating a result of relevance determination with a lawsuit performed by a user with respect to document data, that is, the presence or absence of the relevance. The performance information may represent a classification code assigned by a user to document data indicating the degree of relevance to the lawsuit.

The progress information refers to information relating to the speed of relevance determination performed by a user. Specifically, the progress information refers to the number of pieces of document data for which the user performs the relevance determination per unit of time. The progress information may be the number of pieces of document data for which the user performs the relevance determination per unit of time with respect to the entirety of the document data for which the relevance determination is necessary. In the present exemplary embodiment, the determination information acquiring unit acquires a time taken for a certain user to perform relevance determination of certain document data and a data capacity of the document data, and acquires the progress information from a value obtained by dividing the capacity by the time.

The recording unit 112 records the performance information acquired by the determination acquiring unit 111. In the present exemplary embodiment, the recording unit 112 records the performance information related to a hard disk in the server apparatus 100, but may record the performance information in a database installed outside the server apparatus 100.

The prediction information generating unit 113 generates prediction information. The prediction information refers to information relating to prediction of the relevance determination performed by the user. The prediction information includes at least one of the result information and the progress information. Further, the prediction information generating unit 113 may analyze a feature of the relevance determination performed by the user from the acquired result information, and may generate the prediction information relating to the result information based on a result of the analysis. Further, the prediction information generating unit 113 may further analyze a state of progressing of relevance determination of a different user, and may generate prediction information relating to a progress speed of the relevance determination based on a result of the analysis. In addition, the prediction information generating unit 113 may further analyze a state of progressing of a past relevance determination performed by the user, and may generate prediction information relating to a progress speed of the relevance determination based on a result of the analysis.

In the present exemplary embodiment, the prediction information generating unit 113 generates the prediction information relating to the result information with respect to document data similar to the document data for which the user performs the relevance determination. The prediction information relating to the result information may be generated using a method of a second exemplary embodiment to be described later. Further, the prediction information generating unit 113 may predict the number of pieces of document data that is reviewed by the user per unit of time and a data capacity thereof, from the progress information acquired by the determination acquiring unit 111 up to the current time.

The information comparing unit 114 compares the performance information with the prediction information. The information comparing unit 114 performs the comparison when the prediction information and the performance information include the same information. Specifically, the information comparing unit 114 may compare the prediction information including the result information with the performance information including the result information, or may compare the prediction information including the progress information with the performance information including the progress information. Further, the information comparing unit 114 may compare the prediction information including both the progress information and the result information with the performance information including both the progress information and the result information.

The information comparing unit 114 notifies the icon generating unit 115 of a comparison result.

The icon generating unit 115 generates an icon based on the comparison result. Further, the icon generating unit 115 may change a display format of at least one of a motion, a serif, and an expression of the icon based on the comparison result.

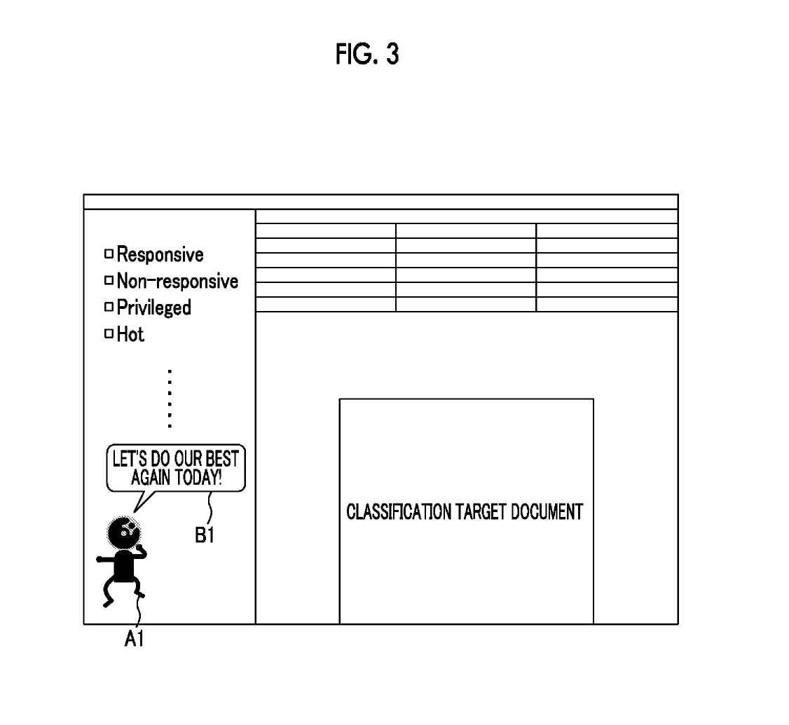

The icon is provided to present an evaluation to a user. The icon may be a friendly character, for example. FIG. 3 is a schematic diagram of a review screen I1 in a state where the icon generating unit 115 in the present embodiment presents an icon. a1 in FIG. 3 represents an icon generated by the icon generating unit 115, and b1 in FIG. 3 represents evaluation content as a serif.

The evaluation refers to feedback with respect to relevance determination performed by a user. The evaluation may be performed based on a comparison result. Specifically, for example, when progress information acquired as performance information is significantly slower in determination speed than progress information predicted as prediction information, a comment for urging improvement of the determination speed may be indicated as the evaluation. Further, when predicted result information is different from result information acquired as performance information, the evaluation may be presented for arousing attention.

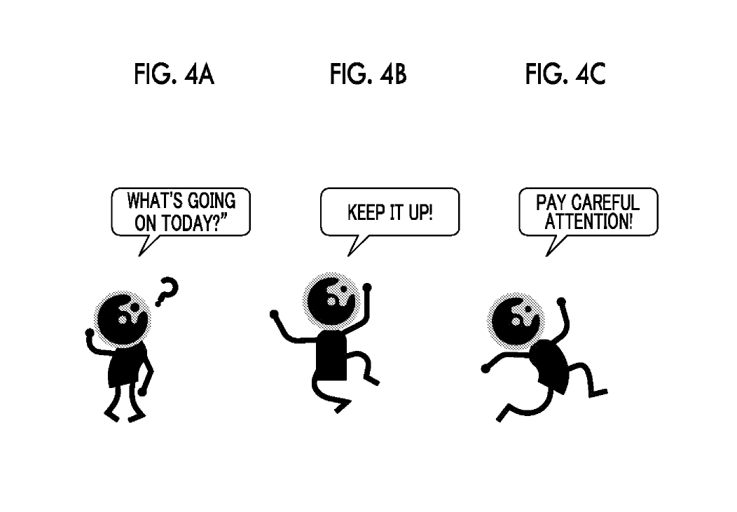

Processes of the icon generating unit 115 will be specifically described using, as an example, a case where the information comparing unit 114 compares the performance information with the prediction information relating to the progress information. FIGS. 4A to 4C are diagrams illustrating an example of icons generated by the icon generating unit 115. It is assumed that the prediction information predicted by the prediction information generating unit 113 from the performance information up to the current time is 50 pieces of document data per unit of time.

FIG. 4A represents an icon saying “What's going on today?” while tilting its head with an annoying expression. This icon is generated when the performance information acquired by the determination information acquiring unit is significantly less than 50 pieces. Thus, it is possible to urge the user to improve the review speed.

FIG. 4B represents an icon saying “Keep it up!” while cheering with a smiling expression. This icon is generated when both the prediction information and the performance information are the same progress information. Thus, it is possible to make the user feel confident of the review at a current pace.

FIG. 4C represents an icon saying “Pay careful attention” while running with a painful expression. This icon is generated in order to prompt the user to pay attention when the pace of the performance information exceeds the pace of the prediction information. Thus, it is possible to prevent the user from performing relevance determination without carefully reading the document data.

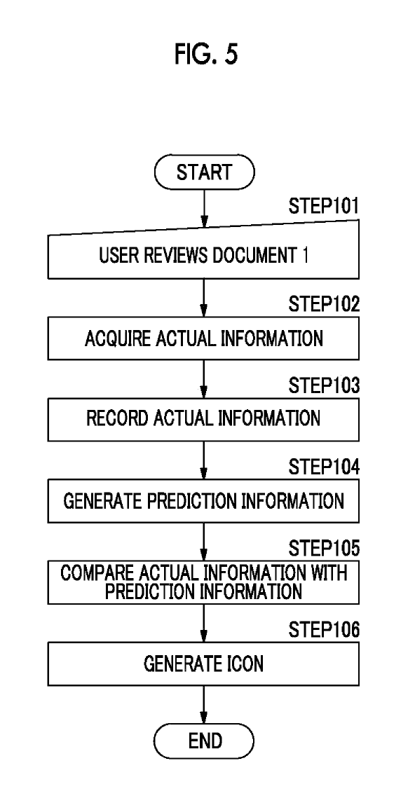

Next, a processing flow of the forensic system according to the present exemplary embodiment will be described with reference to FIG. 5.

If it is determined that certain document data (Document 1) is related to a lawsuit by a user (STEP 101), the determination information acquiring unit acquires performance information with respect to Document 1 (STEP 102). Specifically, the determination information acquiring unit acquires result information indicating that Document 1 is related to the lawsuit and progress information obtained by dividing the data size of Document 1 by the time taken for determination with respect to Document 1 which are obtained as the performance information. The acquired performance information is recorded in the hard disk of the server apparatus 100 by the recording unit 112 (STEP 103).

Then, the prediction information generating unit 113 generates prediction information from past performance information or performance information related to a different user (STEP 104). The information comparing unit 114 compares the performance information with the prediction information (STEP 105). The icon generating unit 115 generates an icon based on a comparison result, and presents evaluation of the relevance determination to the user at any time (STEP 106).

### Second Exemplary Embodiment

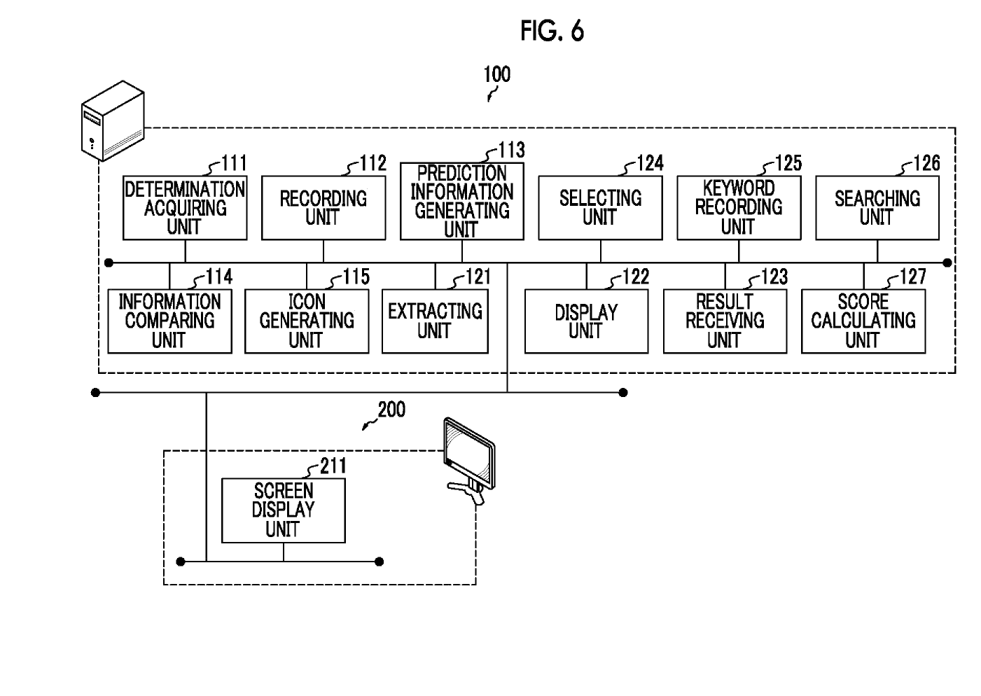

Hereinafter, a second exemplary embodiment of the invention will be descried with reference to FIGS. 6 to 8.

A forensic system according to the second exemplary embodiment of the invention acquires digital information recorded in a plurality of computers or a server and analyzes the acquired digital information. The forensic system includes a determination acquiring unit 111 that acquires, as performance information, at least one of result information indicating a result of determination of relevance of a plurality of pieces of document data included in the digital information to a lawsuit performed by a user and progress information indicating information relating to a progress speed of the relevance determination performed by the user; a recording unit 112 that records the performance information acquired by the determination acquiring unit 111; a prediction information generating unit 113 that generates prediction information relating to at least one of the result information and the progress information; an information comparing unit 114 that compares the performance information with the prediction information; and an icon generating unit 115 that generates an icon for presenting evaluation of the relevance determination performed by the user based on a comparison result in the information comparing unit 114.

Further, the forensic system according to the present exemplary embodiment further includes an extracting unit 121 that extracts a predetermined number of pieces of document data from the digital information; a display unit 122 that displays the extracted document data on a screen; a result receiving unit 123 that receives the result of the relevance determination performed by the user with respect to the displayed document data; a selecting unit 124 that classifies the extracted document data, for each determination result, based on the determination result, analyzes and selects a keyword that appears commonly in the classified document data; a keyword recording unit 125 that records the selected keyword; a searching unit 126 that searches for the keyword recorded in the keyword recording unit 125 from the document data; and a score calculating unit 127 that calculates a score indicating the relevance between the determination result and the document data using a search result in the searching unit 126 and an analysis result in the selecting unit 124. Here, the prediction information generating unit 113 generates the prediction information relating to the result information using the score.

FIG. 6 is a block diagram of the forensic system according to the present exemplary embodiment.

The server apparatus 100 includes the determination acquiring unit 111, the recording unit 112, the prediction information generating unit 113, the information comparing unit 114, the icon generating unit 115, the extracting unit 121, the display unit 122, the result receiving unit 123, the selecting unit 124, the keyword recording unit 125, the searching unit 126, and the score calculating unit 127.

In the present exemplary embodiment, the respective components are mounted on the server apparatus 100, but may be mounted on separate housings.

The client terminal 200 includes a screen display unit 211 that displays a review screen I1 shown in FIG. 2. A user called a reviewer is connected to the server apparatus 100 through the client terminal 200, and performs review on the review screen I1.

Functions of the respective components will be descried with reference to FIG. 6.

The extracting unit 121 extracts document data from the digital information. The extracting unit 121 extracts the document data from the digital information via random sampling. Further, the extracting unit 121 may extract the document data based on attributes such as the updating time and the date of the document data.

The display unit 122 displays the extracted document data. Specifically, the display unit 122 sends an instruction to display the extracted document data on the client terminal 200 that is used by the user.

The result receiving unit 123 receives a result of relevance determination performed by a user.

The selecting unit 124 selects a keyword. The selecting unit 124 may analyze and select the keyword that appears commonly in document data for which the same determination result is obtained.

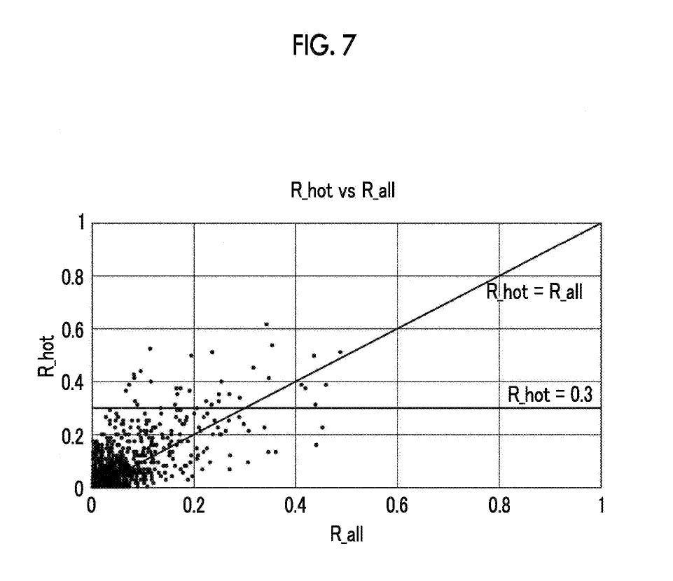

FIG. 7 is a graph illustrating a result obtained by analyzing a keyword that frequently appears commonly in document data for which it is determined by a user that the document data is related to a lawsuit by the selecting unit 124. In FIG. 7, a longitudinal axis R_hot represents a ratio of document data for which it is determined by the user that the document data is related to the lawsuit, including a keyword selected as a keyword connected to the document data for which it is determined by the user that the document data is related to the lawsuit, among the entirety of the document data for which it is determined by the user that the document data is related to the lawsuit. A transverse axis R_all represents a ratio of document data including a keyword searched for in the searching unit 126 to be described later among the entirety of the document data reviewed by the reviewer. In the present exemplary embodiment, the selecting unit 124 selects keywords plotted in an upper part with reference to a straight line R_hot=R_all as keywords common in document data for which it is determined by the user that the document data is related to the lawsuit (STEP 152).

The “keyword” refers to a gathering of a character string having a certain meaning in a certain language. For example, keywords in a sentence “perform document classification” may be “document”, “classification”, and “perform”.

The keyword recording unit 125 records a keyword. The keyword recording unit may be provided as a database.

The searching unit 126 searches for a keyword from document data.

The score calculating unit 127 calculates a score of document data. The score calculating unit 127 may calculate the score based on an evaluation value of a keyword included in the document data. The evaluation value may be calculated based on appearance frequency or the amount of transmission information related to the keyword in the document, and may be the amount of information related to each keyword shown in the document data.

The score refers to the degree of relevance to the lawsuit in certain document information. The score is calculated based on a keyword included in the document data. For example, document data including a keyword having higher necessity for submission in the lawsuit may have a higher score. The document data may be assigned an initial value of the score based on a predetermined condition. For example, the initial score may be calculated based on a keyword that appears in the document data and an evaluation value of each keyword.

The score calculating unit 127 may calculate the score based on a keyword that appears in a document group and a weight of each keyword using the following expression.

Expression 1

Scr=Σᵢ₌₀^{N}i*(mᵢ*wgtᵢ²)/Σᵢ₌₀^{N}i*wgtᵢ² (1)

mᵢ: appearance frequency of i-th keyword or related term

wgtᵢ: weight of i-th keyword or related term

The weight of each keyword is determined based on the amount of transmission information related to each keyword. The weight may be learned using the following expression.

Expression 2

wgt_{i,L}=\sqrt{wgt_{L-1}²+γ_{L}wgt_{i,L}²−φ}=\sqrt{wgt_{i,L}²+Σₗ₌₁^{L(γ}ₗwgt_{i,l}²−φ} (2)

Wgt_{i,0}: weight of i-th selected keyword before learning (initial value)

Wgt_{i,L}: weight of i-th selected keyword after L-th learning

γL: learning parameter in L-th learning

Θ: threshold value of learning effect

The prediction information generating unit 113 generates prediction information relating to result information based on the score calculated by the score calculating unit 127. Specifically, the prediction information generating unit 113 generates the prediction information by predicting that document data of which a score exceeds a predetermined threshold value is related to the lawsuit, and by predicting that document data of which a score does not exceed the threshold value is not related to the lawsuit.

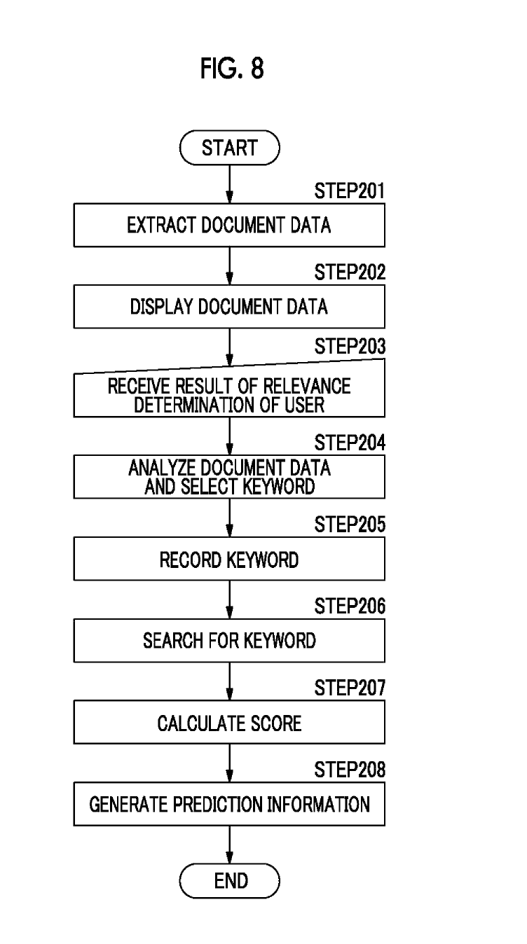

A processing flow of the prediction information generating process in the present exemplary embodiment will be described with reference to FIG. 8. First, the extracting unit 121 extracts a predetermined number of pieces of document data from digital information (STEP 201). Then, the display unit 122 displays the extracted document data on a screen of the client terminal 200 (STEP 202). The result receiving unit 123 receives the result of the relevance determination performed by the user (STEP 203), and the selecting unit 124 analyzes the document data from the result of the relevance determination performed by the user to select a keyword (STEP 204). The selected keyword is recorded by the keyword recording unit 125 (STEP 205). Then, the searching unit 126 searches for the recorded keyword from each piece of document data (STEP 206), and the score calculating unit 127 calculates a score of each piece of document data using the expression (1) (STEP 207). The prediction information generating unit 113 generates the prediction information relating to the result information based on the calculated score (STEP 208).

Other configurations and functions are the same as in the first exemplary embodiment.

### Other Exemplary Embodiments

The icon generating unit 115 may present an evaluation according to content of document data for which a user is currently performing review, unlike the first exemplary embodiment and the second exemplary embodiment.

For example, the icon generating unit 115 may present an evaluation based on creation date and time, a creator and a security level of the document data. Specifically, when a user performs review with respect to document data created by a person having high relevance to a lawsuit, the icon generating unit 115 may generate an icon for arousing attention regarding the present evaluation and may represent an evaluation.

Other configurations and functions are the same as in the first exemplary embodiment.

When the forensic system acquires digital information recorded in a plurality of computers or a server and analyzes the acquired digital information, and includes: the determination acquiring unit 111 that acquires, as the performance information, at least one of the result information indicating the result of the determination of the relevance of the plural pieces of document data included in the digital information to the lawsuit performed by the user and the progress information indicating the information relating to the progress speed of the relevance determination performed by the user; the recording unit 112 that records the performance information acquired by the determination acquiring unit 111; the prediction information generating unit 113 that generates the prediction information relating to at least one of the result information and the progress information; the information comparing unit 114 that compares the performance information with the prediction information; and the icon generating unit 115 that generates the icon for presenting the evaluation for the relevance determination performed by the user based on the comparison result in the information comparing unit 114, it is possible to appropriately perform feedback to a user using the icon according to a state of progressing of review or the degree of relevance of document data during review with a lawsuit, to thereby make it possible to maintain the motivation of the user and to improve efficiency of the review.

Further, when the prediction information generating unit 113 further analyzes the feature of the relevance determination performed by the user from the acquired result information and generates the prediction information relating to the result information based on the result of the analysis, it is possible to predict a result of relevance determination performed by the user with respect to certain document data using the system, and when the prediction result is different from an performance determination result of the user, it is possible to arouse the attention of the user.

Further, when the prediction information generating unit 113 further analyzes the state of progressing of the relevance determination of the different user and generates the prediction information relating to the progress speed of the relevance determination based on the result of the analysis, it is possible to predict a result of determination of a specific user with respect to certain document data from a result of relevance determination of a different user using the system, and when the prediction result is different from an performance determination result of the user, it is possible to arouse the attention of the user.

In addition, when the prediction information generating unit 113 further analyzes the state of progressing of the past relevance determination performed by the user and generates the prediction information relating to the progress speed of the relevance determination based on the result of the analysis, it is possible to predict a progress speed of review from a past progress speed of a certain user, and when the predicted progress speed is different from actual progress speed of the user, it is possible to arouse the attention of the user.

Furthermore, when the icon generating unit 115 changes the display format of at least one of the motion, the serif and the expression of the icon based on the comparison result, it is possible to present appropriate evaluation according to situations of the user.

### REFERENCE SIGNS LIST

100 Server Apparatus
111 Determination Acquiring Unit
112 Recording Unit
113 Prediction Information Generating Unit
114 Information Comparing Unit
115 Icon Generating Unit
121 Extracting Unit
122 Display Unit
123 Result Receiving Unit
124 Selecting Unit
125 Keyword Recording Unit
126 Searching Unit
127 Score Calculating Unit
200 Client Terminal
211 Screen Display Unit
290 Indicating Unit
I1 Review Screen

1. A forensic system that acquires digital information recorded in a plurality of computers or a server and analyzes the digital information, comprising:
a determination acquiring unit that acquires, as performance information, at least one of result information indicating a result of a determination, performed by a user, of whether or not a plurality of pieces of document data included in the digital information is related to a lawsuit and progress information indicating information relating to a progress speed of the determination performed by the user;
a recording unit that records the performance information acquired by the determination acquiring unit;
a prediction information generating unit that generates prediction information relating to at least one of the result information and the progress information;
an information comparing unit that compares the performance information with the prediction information; and
an icon generating unit that generates an icon for presenting an evaluation of the determination, performed by the user, of whether or not the plurality of pieces of document data included in the digital information is related to the lawsuit based on a comparison result of the performance information with the prediction information by the information comparing unit.

2. The forensic system according to claim 1,
wherein the prediction information generating unit analyzes a feature of the determination performed by the user from the result information, and generates the prediction information relating to the result information based on a result of an analysis of the feature of the determination performed by the user from the result information.

3. The forensic system according to claim 1,
wherein the prediction information generating unit further analyzes a state of progress of a relevance determination of a different user, and generates second prediction information relating to a progress speed of the relevance determination of the different user based on a result of the analysis of the state of progress of the relevance determination of the different user.

4. The forensic system according to claim 1,
wherein the prediction information generating unit further analyzes a state of progress of a past relevance determination performed by the user, and generates prediction information relating to a progress speed of the past relevance determination based on a result of the analysis of the state of progress of the past relevance determination performed by the user.

5. The forensic system according to claim 1,
wherein the icon generating unit changes a display format of at least one of a motion, a serif and an expression of the icon based on the comparison result.

6. The forensic system according to claim 1, further comprising:
an extracting unit that extracts the plurality of pieces of document data from the digital information to generate extracted document data;
a display unit that displays the extracted document data on a screen;
a result receiving unit that receives the result information of the determination performed by the user with respect to the plurality of pieces of document data;
a selecting unit that classifies the extracted document data, for each determination result, based on the determination made by the user, and analyzes and selects a keyword that appears commonly in the extracted document data;
a keyword recording unit that records the keyword;
a searching unit that searches for the keyword recorded in the keyword recording unit from the extracted document data; and
a score calculating unit that calculates a score indicating a relevance between the determination result and the extracted document data using a search result of the searching unit and an analysis result of the selecting unit,
wherein the prediction information generating unit generates the prediction information relating to the result information using the score.

7. A forensic method for acquiring digital information recorded in a plurality of computers and a server and analyzing the digital information, comprising:
acquiring, by a computer, as performance information, at least one of result information indicating a result of a determination, performed by a user, of whether or not a plurality of pieces of document data included in the digital information is related to a lawsuit and progress information indicating information relating to a progress speed of the determination performed by the user;
recording, by the computer, the performance information which is acquired,
generating, by the computer, prediction information relating to at least one of the result information and the progress information;
comparing, by the computer, the performance information with the prediction information; and
generating, by the computer, an icon for presenting an evaluation of the determination, performed by the user, of whether or not the plurality of pieces of document data included in the digital information is related to the lawsuit based on a comparison result of the performance information with the prediction information.

8. A non-transitory computer readable medium comprising instructions executable by at least one processor and causing the at least one processor to perform a method of acquiring digital information recorded in a plurality of computers and a server and analyzing the digital information, the method comprising:
acquiring, as performance information, at least one of result information indicating a result of a determination, performed by a user, of whether or not a plurality of pieces of document data included in the digital information is related to a lawsuit and progress information indicating information relating to a progress speed of the determination performed by the user;
recording the performance information which is acquired;
generating prediction information relating to at least one of the result information and the progress information;
comparing the performance information with the prediction information; and
generating an icon for presenting an evaluation of the determination, performed by the user, of whether or not the plurality of pieces of document data included in the digital information is related to the lawsuit based on a comparison result of the performance information with the prediction information.
